(19) United States
(12) Patent Application Publication
(10) Pub. No.: US 2013/0116844 A1
(43) Pub. Date: May 9, 2013

(54) GRID LOAD SYNCHRONIZATION DEVICE AND METHOD

(71) Applicants: John M. McNally, Chicago, IL (US); Peter Gottlieb, Dobbs Ferry, NY (US)

(72) Inventors: John M. McNally, Chicago, IL (US); Peter Gottlieb, Dobbs Ferry, NY (US)

(73) Assignee: A123 Systems, Inc., Waltham, MA (US)

(21) Appl. No.: 13/513,024

(22) PCT Filed: Dec. 3, 2010
(86) PCT No.: PCT/US10/58911

§ 371 Date: Jan. 8, 2013

Related U.S. Application Data
(60) Provisional application No. 61/266,219, filed on Dec. 3, 2009.

(51) Int. Cl. H02J 3/14

(52) U.S. Cl. CPC H02J 3/14
USPC 700/295

(57) ABSTRACT

The grid load synchronization system described herein permits proactive mitigation of the effects of large loads transitioning on and off the power grid and the resultant risks and power quality issues associated therewith. The disclosed proactive system permits a grid-connected power consumer to synchronize demand with power storage equipment in real time using a digital communication link. The power consumer transmits requests to bring a load online or offline to a control site. The control site coordinates power grid source(s) and power grid loads to maintain power quality when loads go on and offline. The control sites manage requests from multiple power consumers and schedule the various loads for the consumers to mitigate the effects of large loads transitioning on and off the power grid. The resulting power quality can be guaranteed when adequate battery resources are made proactively available, rather than reacting to line conditions to engage compensation actions.

### CROSS REFERENCE TO RELATED APPLICATIONS

This application claims the benefit of U.S. Provisional Application 61/266,219, filed on Dec. 3, 2009, the entire contents of which are hereby incorporated by reference.

### BACKGROUND

Various systems and methods have been proposed to balance power on electrical grids. For example, U.S. Pat. No. 6,674,267 Wernersson relates to a method and a device for compensation of the consumption of reactive power by an industrial load. However, Wernersson does not address rapid power demand changes of industrial loads, it merely compensates for non-unity power factor loads.

Other prior art methodology includes compensating for voltage dips, frequency variations, and power factory variations on-the-fly. Devices monitor the grid conditions and react by inserting power in such a direction and magnitude that corrects the problem. However, this technology reacts to line fluctuations to determine the need to provide compensation. The reaction time between sensing a line anomaly and compensation action could result in grid disturbances that reduce power quality for other grid customers and their systems. By definition, this system always will have line disturbances. The smaller the allowed disturbances, the more reactive and inefficient the compensation system needs to be.

Another prior art methodology buffers the large industrial loads with an uninterruptible power supply system which corrects power factor and gently transitions power surges from its loads from internal battery to the input power port. However, this technology requires a fully sized power converter to run the industrial loads. The converter must be sized to handle the large inrush of power, as well as ongoing loads continuously. This method is inefficient because the continuous power conversion consumes power in the form of heat losses. It also is costly because of the power conversion systems required to convert AC to DC, and back to AC.

A further prior art methodology senses current going into a large industrial load, which provides a signal to a large battery system to compensate an equal amount of current into the grid simultaneously with the measured inrush of current into the large load. However, this methodology requires the battery system to be engaged and running in idle continuously in order to react quickly enough to current inrushes measured at the industrial loads. This continuous operation consumes power and reduces the lifetime of the power conversion devices.

### SUMMARY

The grid load synchronization system described herein permits proactive mitigation of the effects of large loads transitioning on and off the power grid and the resultant risks and power quality issues associated therewith. The disclosed proactive system permits a grid-connected power consumer to synchronize demand with power storage equipment in real time using a digital communication link. The power consumer transmits requests to bring a load online or offline to a control site. The control site coordinates power grid source(s) and power grid loads to maintain power quality when loads go on and offline. The control sites manage requests from multiple power consumers and schedule the various loads for the consumers to mitigate the effects of large loads transitioning on and off the power grid. The resulting power quality can be guaranteed when adequate battery resources are made proactively available, rather than reacting to line conditions to engage compensation actions.

In one aspect, the disclosure relates to a grid synchronization system for use on a power grid, said grid stabilization system including a load controller located at a customer site on the power grid, said load controller programmed to transmit a request for permission to change a load on the power grid at the customer site, a grid stabilization controller located remotely from the customer site, and a grid stabilization subsystem on the power grid located remotely from the customer site. The grid stabilization system includes an energy storage system for storing energy; a power transfer interface for electrically coupling the energy storage system to the power grid and providing a transfer of power between the energy storage system and the power grid; and a power transfer controller for controlling the power transfer interface, wherein the grid stabilization controller is programmed to receive the request from the load controller, determine a future event time at which the load controller is to implement the requested load change, transmit said future event time to the load controller, and instruct the power transfer controller to cause the power transfer interface to implement a power transfer between the power grid and the energy storage system beginning at said future event time.

In some embodiments, the grid stabilization controller and the grid stabilization subsystem are co-located. In some embodiments, the grid stabilization controller is located remotely from the grid stabilization subsystem. In some embodiments, the grid stabilization system includes a plurality of grid stabilization subsystems all located remotely from the customer site and at different locations on the power grid, said plurality of grid stabilization subsystems including said first-mentioned grid stabilization subsystem and wherein each grid stabilization subsystem of said plurality of grid stabilization subsystems includes an energy storage system for storing energy, a power transfer interface for electrically coupling the energy storage system to the power grid and providing a transfer of power between the energy storage system and the power grid and a power transfer controller for controlling the power transfer interface, wherein the grid stabilization controller is programmed to also instruct a power transfer controller in another one of the plurality of grid stabilization subsystems in addition to the first-mentioned grid stabilization subsystem to cause the power transfer interface in said other grid stabilization subsystem to implement a power transfer between the power grid and the energy storage system in said other grid stabilization subsystem beginning at said future event time.

In some embodiments, the energy storage system is a battery. In some embodiments, the grid stabilization system includes a plurality of customer sites all located remotely from the grid stabilization controller and at different locations on the power grid, said plurality of customer sites including said first-mentioned customer site, wherein each customer site comprises a load controller to transmit a request for permission to change a load on the power grid at the customer site. In some embodiments, the grid stabilization controller receives the request from the load controller through an internet connection. In some embodiments, each of the customer sites and the grid stabilization subsystems comprise a global positioning system (GPS) clock for marking the future event time. In some embodiments, the customer site and the grid stabilization system are connected to a network time protocol (NTP) server in order to mark the future event time. In some embodiments, the grid stabilization controller receives grid measurement information from the customer site. In some embodiments, the grid stabilization controller receives load quantity, ramp time, and inrush peak length information from the customer site. In some embodiments, the grid stabilization controller receives grid measurement information from the grid stabilization subsystem. In some embodiments, the grid measurements comprise power factor, watts, VARs, and voltage. In some embodiments, each of the customer sites and the grid stabilization subsystem sites comprise a synchrophasor. In some embodiments, a change in a load includes bringing a load online. In some embodiments, a change in a load includes taking a load offline.

In one aspect, the present disclosure relates to a method for synchronizing loads on a power grid, the method including receiving a request for permission to change a load on the power grid from a load controller, determining a future event time at which the load controller is to implement the requested load change, transmitting said future event time to the load controller, and instructing a power transfer controller to cause a power transfer interface to implement a power transfer between the power grid and an energy storage system beginning at said future event time, wherein the power transfer mitigates the load change. In some embodiments, the energy storage system comprises a battery. In some embodiments, the method includes receiving the request from the load controller through an internet connection.

In some embodiments, each of the customer sites and the grid stabilization subsystems include a GPS clock for marking the future event time. In some embodiments, the customer site and the grid stabilization system are connected to a NTP server in order to mark the future event time. In some embodiments, the method includes receiving grid measurement information from the customer site. In some embodiments, the method includes receiving load quantity, ramp time, and inrush peak length information from the customer site. In some embodiments, the method includes receiving grid measurement information from the grid stabilization subsystem. In some embodiments, the grid measurements comprise power factor, watts, VARs, and voltage. In some embodiments, each of the customer sites and the grid stabilization subsystem sites comprise a synchrophasor. In some embodiments, a change in a load comprises bringing a load online. In some embodiments, a change in a load comprises taking a load offline.

### DRAWINGS

The disclosed subject matter is described with reference to the following drawings, which are presented for the purpose of illustration only and which are not intended to be limiting of the invention.

FIG. 1 is a schematic of the grid load synchronization according to an embodiment of the present disclosure.

FIG. 2 is another schematic of the grid load synchronization according to an embodiment of the present disclosure.

### DESCRIPTION

The disclosed grid load synchronization system is a system that provides the synchronization of large loads transitioning onto or off of a power grid with grid stabilization resources (for example, battery systems) available to mitigate the effects of these transitions. By precisely synchronizing these grid-connected resources and loads, the negative effects on grid power quality and risk of outage related to large load changes can be minimized or eliminated. Importantly, this system can assist sequencing the restart of large loads after a power outage (or other anomaly that results in a disconnect of loads), thereby preventing simultaneous restart of these loads and causing instability of power grid voltage and a potential grid outage. Additionally, the injection of reactive power into the grid to compensate for startup of large reactive loads can minimize risk of transmission line over-current trip and resulting secondary power outage.

The disclosed grid load synchronization system can be a collection of controllers which communicate over a network to precisely coordinate industrial loads and grid power sources and that proactively synchronize the startup and shutdown of large industrial loads with the operation of a stationary grid stabilization system. The disclosed grid load synchronization system can reduce machine downtime at customer sites, mitigate the negative effects of voltage drops in the power grid, and improve performance of the grid.

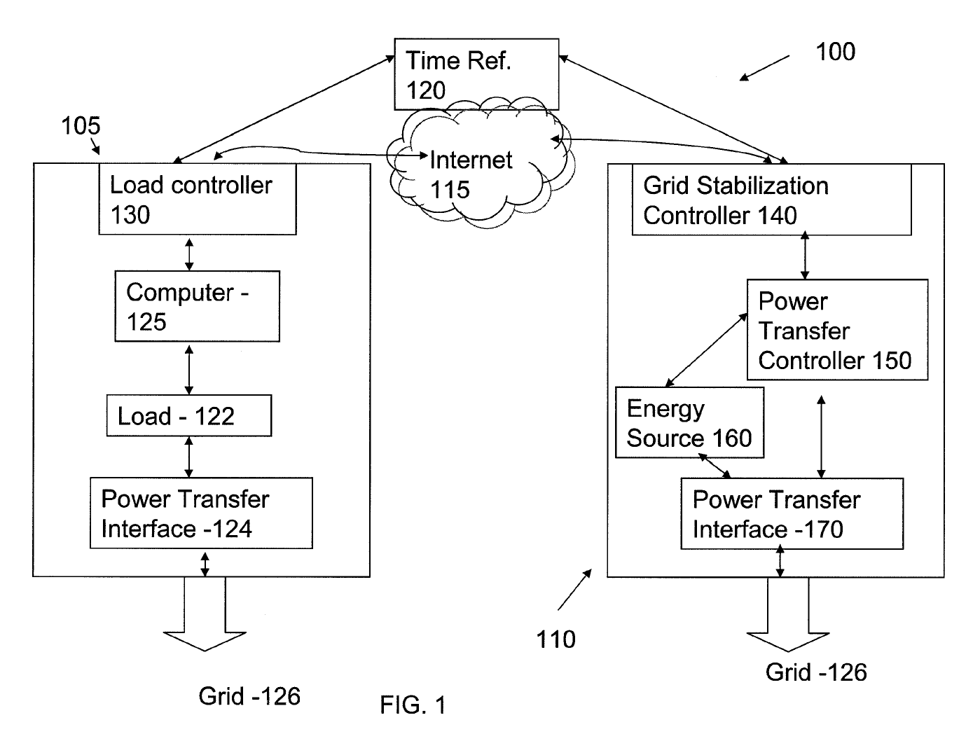

FIG. 1 is a schematic of grid load synchronization system 100 grid load synchronization system 100 includes a load controller 130 at customer site 105 and a grid stabilization controller 140 located remotely from customer site 105. FIG. 1 depicts grid stabilization controller 140 located at grid stabilization subsystem site 110. Grid stabilization controller 140 is connected via a secure internet connection 115 to customer site 105. Secure internet connection 115 is secure shell (SSH), but could be any secure communication protocol. Grid stabilization controller 140 receives requests by the customer site 105 for permission to change a load at customer site 105. In response to such requests, grid stabilization controller 140 determines a future event time at which customer site 105 can change the load and communicates the future event time to both customer site 105 and to grid stabilization subsystem site 110. Grid stabilization controller 140 can be a processor, controller or a computer capable of performing the functionality described herein.

Customer site 105 can be an industrial site/power consumer/customer that has a plurality of high electrical load machines or devices 122. Customer site 105 is connected to grid 126 and to grid stabilization controller 140. Grid stabilization controller 140 is in communication with customer site 105 though an internet connection. Customer site 105 includes a computer 125. Computer 125 can be a programmable logic controller that is used to control loads on a wired grid, e.g., computer 125 controls the connection and disconnection of loads from grid 126. Customer site 105 also includes load controller 130. Load controller 130 is connected to computer 125 through a MODBUS TCP connection 135 and communicates with a corresponding grid stabilization controller 140 at grid stabilization subsystem site 110 through secure internet connection 115 regarding load changes at customer site 105. Connection 135 also can be a MODBUS RTU connection. Customer site also includes a power transfer interface 124, for example, an inverter, to connect load 122 to grid 126.

As noted above, grid stabilization subsystem site 110 includes grid stabilization controller 140. Grid stabilization controller 140 is connected through a MODBUS TCP connection 145 to a power transfer controller 150. Power transfer controller 150 and grid stabilization controller 140 are connected to an energy storage system 160 and a power transfer interface 170, for example, an inverter. Energy storage system 160 can be any type of bi-directional power source capable of instantaneously sinking or sourcing power to the power grid and can sustain the power delivery for a time period long enough to counteract the load transitioning on or off the grid. For example, energy storage system 160 can be any electrochemical, mechanical or thermal energy storage device. Further, energy storage system 160 can be, for example, a grid battery system large enough to supply or sink sufficient power to nullify fluctuations caused by bringing loads online or taking them offline, such as batteries manufactured by A123 Systems, Inc. (Watertown, Mass.). Specifically, energy storage system 160 can include a plurality of two megawatt battery modules that can provide zero to two megawatts of power each on demand.

Power transfer controller 150 controls the injection of power to grid 126 and the absorption of power from grid 126 through power transfer interface 170. Power transfer controller 150 can be a processor, a controller, or a computer. Selectable amounts of power can be delivered by the power transfer interface 170 from energy storage system 160 to the grid 126 to mitigate the effect of transitioning large loads on or off the grid 126 at customer site 105. The power transfer interface 170 can ramp power in or out and can sink or source power based upon load profiles provided or selected by grid stabilization controller 140. Load profiles can be stored at grid stabilization controller 140 for various types of loads or grid stabilization controller 140 can create the profile. The profile includes the characteristics of the power to be injected into or absorbed from the grid 126. Power transfer interface 170 can provide all required power instantaneously or it can modulate the delivery of power over time. For example, power can be ramped over a set period of cycles or time, or the power can applied at 110% for a certain number of cycles and then reduced periodically over a number of cycles. The load profiles are designed to respond to the characteristics of the load, so that the grid would see little or no impact of the load coming on or off the grid. In order to more accurately stabilize the grid 126, grid stabilization subsystem site 110 also can measure characteristics of the grid 126 at grid stabilization subsystem site 110, for example, voltage, power factor, VARS, and watts, etc. Grid stabilization controller 140 can determine the amount and type of power for power transfer interface 170 to inject to or absorb from the grid to counteract the load coming on or off the grid 126 based not only on a profile of the load, but also on the present conditions on the grid 126 at grid stabilization subsystem site 110. Further, customer site 105 can measure local grid conditions, for example, voltage, power factor, VARS, and watts, and transmit that information through load controller 130 to grid stabilization controller 140. Grid measurements at customer site 105 also can be used by grid stabilization controller 140 to determine the appropriate mitigating power to inject into or absorb from the grid 126.

In order to ensure that customer site 105 changes its load at the same future set time that grid stabilization subsystem 110 mitigates the load change, both systems need to have accurate clocks. In one embodiment, grid load synchronization system 100 includes an internet connected time reference 120 capable of synchronizing time references at customer site 105 and grid stabilization subsystem site 110. Internet connected time reference 120 can be a network time protocol (“NTP”) server. The NTP server ensures synchronous operation of the system by making sure that the clocks at different locations are synchronized.

Alternatively, highly accurate real time clocks at customer site 105 or grid stabilization subsystem site 110 can provide the synchronization between customer programmable controller 130 and control site controller 140 instead of relying on NTP servers. Any time synchronization scheme can be implemented as long as it can be accurate to within about a couple of cycles, e.g., within about 10 milliseconds. For example, each of load controller 130 and grid stabilization controller 140 can include a GPS clock for synchronizing time references at customer site 105 and grid stabilization subsystem site 110, respectively. The GPS clock permits time synchronization in the sub millisecond range, while the NTP server permits time synchronization in the range of about 5 milliseconds to about 10 milliseconds. Different means to communicate with customer programmable controller 130 could be used, including SNMP, Ethernet IP, or other protocols.

The communication methods can include twisted wire pair, coaxial cable, fiber optic, or radio frequency wireless telemetry. Additionally, loads can be synchronized to be turned on or off according to the availability of battery resources. For example, the customer can be given a delayed activation time until other loads have successfully been activated and compensated for. Further, the customer can be notified that the load cannot be added.

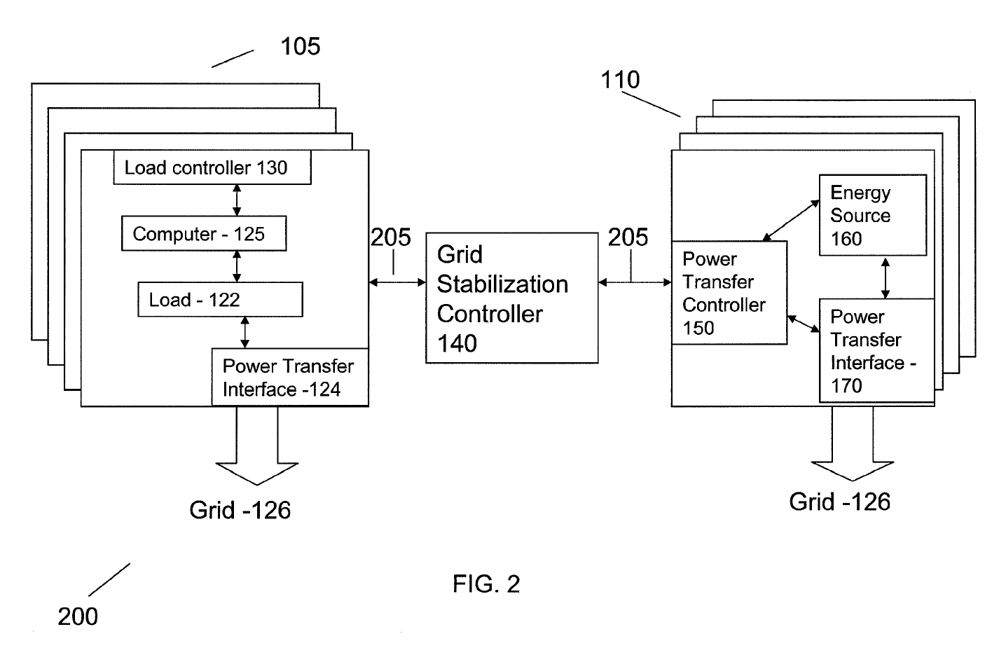

FIG. 2 depicts another embodiment of a grid synchronization system 200. Grid synchronization system 200 includes a plurality of customer sites 105 and grid stabilization subsystem sites 110. Each of the customer sites 105 and grid stabilization subsystem sites 110 are connected to both the grid through a power transfer controller 124, 170, respectively, and to a grid stabilization controller 140. In this embodiment, grid stabilization controller 140 is located remotely from both customer sites 105 and grid stabilization subsystem sites 110. Each of the customer sites 105 and grid stabilization subsystem sites 110 are connected to grid stabilization controller 140 through an internet connection 205 via load controllers 130 located in customer sites 105 or power transfer controller 150, located in each of grid stabilization subsystem sites 110.

Grid stabilization controller 140 acts as an intermediary that manages and validates requests from customer sites 105 for changes to the load at customer site 105. The customer supplies credentials along with its request for power, which are then validated by grid stabilization controller 140. Once grid stabilization controller 140 has the request for permission to change a load on a the power grid at customer site 105, grid stabilization controller 140 can determine which available grid stabilization subsystem site or sites 110 will be used to mitigate the load change. For example, grid stabilization controller 140 could determine that one grid stabilization subsystem site should be used to effectively mitigate the load change. Or, grid stabilization controller 140 could determine that three grid stabilization subsystem sites should be used. If grid stabilization controller 140 determines that more than one grid stabilization subsystem site should be used, grid stabilization controller 140 can allocate the power profile among the selected grid stabilization subsystem sites. For example, one grid stabilization subsystem site could impart 40% of the total power profile onto the grid, while the other two could each impart 30% of the total power profile onto the grid. Grid stabilization controller 140 can use the available grid measurement information from each of the grid stabilization subsystem sites and their locations, for example, the location with respect to the customer site 105, to determine the most effective way to mitigate the load change.

The grid load synchronization system also can include a synchrophasor at each of the grid stabilization controllers and load controllers in the system. The synchrophasors can measure voltages and currents, at each of these locations on the power grid and can output accurately time-stamped voltage and current phasors. Because these phasors are truly synchronized, synchronized comparison of two quantities in real time is possible. These comparisons can be used to assess system conditions. This information can be used to assist the grid stabilization controller to determine how much real or reactive power to inject or absorb.

The grid load synchronization system operates in the following manner:

Step 1: An industrial process or equipment communicating with load controller 130 via standard industrial protocols (MODBUS RTU or MODBUS TCP, for example, or other communications protocol) requests permission to add a large load at customer site 105 to the power grid 126 or to remove it from the power grid 126.

Step 2: Load controller 130 communicates via standard internet protocols to grid stabilization controller 140 to inform grid stabilization controller 140 of the load change request. Load controller 130 communicates the continuous load quantity, power factor, ramp time, inrush peak and length, and other relevant information. Grid stabilization controller 140 can accept, defer, or reject the request from customer site 105 based upon its ability to respond with power sinking or sourcing given the current state of charge, output state and other parameters that determine the near term capabilities of grid stabilization subsystem sites 110. Grid stabilization controller 140 can accept the request based on contractual settings for the customer and existing conditions on the grid 126 at customer site 105 and grid stabilization subsystem sites 110. If accepted, the load request is coordinated with other load requests from other industrial/customer sites and a future startup time (e.g., a few seconds in the future) is identified as the synchronous event time (SET). Thus, grid stabilization controller 140 takes into account the other load requests and coordinates their timing to minimize their impact on the grid.

Step 3: The SET is forwarded back to load controller 130 and customer computer 125 waits for a “Go” signal to indicate that it is time to transition the load on or off the grid. SET tells load controller 130 when the request can be acted on. At that time, load controller 130 sends a “Go” signal to customer computer 125. Customer computer 125 then disconnects or connects the load depending on the need.

Step 4: Customer computer 125 starts the load at the predetermined SET. Concurrently, grid stabilization subsystem site 110 sources or sinks a similar amount of power at the predetermined SET instantly and then ramps down its source/sink power over several seconds to smooth the effect of the load change.

The grid load stabilization system provides quick validation and synchronization, for example, less than five seconds to request/receive acknowledgement. The transition of the load and the injection of power (or sinking of power) by the grid stabilization subsystem site can occur within a few power cycles because of the synchronization achieved by the NTP protocol or GPS clock. The grid stabilization subsystem site can source/sink power coincident with load startup/shutdown. Thus, rather than reacting to monitored charges on the grid, the grid stabilization subsystem site is able to function proactively in anticipation of (or with foreknowledge) of those changes.

While examples of the present invention have been shown and described, it will be readily apparent to those skilled in the art that various changes and modifications may be made therein without departing from the scope of the invention.

1. A grid synchronization system for use on a power grid, said grid stabilization system comprising:
a load controller located at a customer site on the power grid, said load controller programmed to transmit a request for permission to change a load on the power grid at the customer site;
a grid stabilization controller located remotely from the customer site; and
a grid stabilization subsystem on the power grid located remotely from the customer site, said grid stabilization system comprising:
an energy storage system for storing energy;
a power transfer interface for electrically coupling the energy storage system to the power grid and providing a transfer of power between the energy storage system and the power grid; and
a power transfer controller for controlling the power transfer interface,
wherein the grid stabilization controller is programmed to receive the request from the load controller, determine a future event time at which the load controller is to implement the requested load change, transmit said future event time to the load controller, and instruct the power transfer controller to cause the power transfer interface to implement a power transfer between the power grid and the energy storage system beginning at said future event time.

2. The grid stabilization system of claim 1, wherein the grid stabilization controller and the grid stabilization subsystem are co-located.

3. The grid stabilization system of claim 1, wherein the grid stabilization controller is located remotely from the grid stabilization subsystem.

4. The grid stabilization system of claim 1, further comprising a plurality of grid stabilization subsystems all located remotely from the customer site and at different locations on the power grid, said plurality of grid stabilization subsystems including said first-mentioned grid stabilization subsystem and wherein each grid stabilization subsystem of said plurality of grid stabilization subsystems comprises:
an energy storage system for storing energy;
a power transfer interface for electrically coupling the energy storage system to the power grid and providing a transfer of power between the energy storage system and the power grid; and
a power transfer controller for controlling the power transfer interface,
wherein the grid stabilization controller is programmed to also instruct a power transfer controller in another one of the plurality of grid stabilization subsystems in addition to the first-mentioned grid stabilization subsystem to cause the power transfer interface in said other grid stabilization subsystem to implement a power transfer between the power grid and the energy storage system in said other grid stabilization subsystem beginning at said future event time.

5. The grid stabilization system of claim 1, wherein the energy storage system comprises a battery.

6. The grid stabilization system of claim 1, further comprising a plurality of customer sites all located remotely from the grid stabilization controller and at different locations on the power grid, said plurality of customer sites including said first-mentioned customer site, wherein each customer site comprises a load controller to transmit a request for permission to change a load on the power grid at the customer site.

7. The grid stabilization system of claim 1, wherein the grid stabilization controller receives the request from the load controller through an internet connection.

8. The grid stabilization system of claim 1, wherein each of the customer site and the grid stabilization subsystem comprise a GPS clock for marking the future event time.

9. The grid stabilization system of claim 1, the customer site and the grid stabilization system are connected to a NTP server in order to mark the future event time.

10. The grid stabilization system of claim 1, wherein the grid stabilization controller receives grid measurement information from the customer site.

11. The grid stabilization system of claim 1, wherein the grid stabilization controller receives load quantity, ramp time, inrush peak length information from the customer site.

12. The grid stabilization system of claim 1, wherein the grid stabilization controller receives grid measurement information from the grid stabilization subsystem.

13. The grid stabilization system of claim 12, wherein the grid measurements comprise power factor, watts, VARs, and voltage.

14. The grid stabilization system of claim 1, each of the customer site and the grid stabilization subsystem sites comprise a synchrophasor.

15. The grid stabilization system of claim 1, wherein change a load comprises bringing a load online

16. The grid stabilization system of claim 1, wherein change a load comprises taking a load offline.

17. A method for synchronizing loads on a power grid, the method comprising:
receiving a request for permission to change a load on the power grid from a load controller;
determining a future event time at which the load controller is to implement the requested load change;
transmitting said future event time to the load controller; and
instructing a power transfer controller to cause a power transfer interface to implement a power transfer between the power grid and an energy storage system beginning at said future event time, wherein the power transfer mitigates the load change.

18. The method of claim 17, wherein the energy storage system comprises a battery.

19. The method of claim 17, comprising receiving the request from the load controller through an internet connection.

20. The method of claim 17, wherein each of the customer site and the grid stabilization subsystem comprise a GPS clock for marking the future event time.

21. The method of claim 17, the customer site and the grid stabilization system are connected to a NTP server in order to mark the future event time.

22. The method of claim 17, comprising receiving grid measurement information from the customer site.

23. The method of claim 17, comprising receiving load quantity, ramp time, inrush peak length information from the customer site.

24. The method of claim 17, comprising receiving grid measurement information from the grid stabilization subsystem.

25. The method claim 24, wherein the grid measurements comprise power factor, watts, VARs, and voltage.

26. The method of claim 17, wherein each of the customer site and the grid stabilization subsystem sites comprise a synchrophasor.

27. The method of claim 17, wherein change a load comprises bringing a load online.

28. The method of claim 17, wherein change a load comprises taking a load offline.
